(19) United States
(12) Patent Application Publication
(10) Pub. No.: US 2007/0263672 A1
(43) Pub. Date: Nov. 15, 2007

(54) Adaptive jitter management control in decoder

(75) Inventors: Pasi Ojala, Kirkkonummi (FI); Ari Lakaniemi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/431,421

(22) Filed: May 9, 2006

(51) Int. Cl. H04J 3/06

(52) U.S. Cl. 370/516

(57) ABSTRACT

A method, a chipset, a receiver, a transmitter, an electronic device and a system for enabling a control of jitter management of an audio signal is described, wherein the audio signal is distributed to a sequence of frames that are received via a packet switched network, the received frames comprising active audio frames and non-active audio frames, wherein a concatenation of subsequent active audio frames represents an active audio burst, wherein a discrete information of audio activity of the audio signal via the packet switched network is received, the end of an active audio burst is determined based on the received discrete information of audio activity, and wherein jitter compensation of the received frames is controlled on the basis of the determined end of an active audio burst. The invention further relates to a corresponding software program product storing a software code for controlling jitter management of an audio signal.

### FIELD OF THE INVENTION

This invention relates to a method, to a chipset, to a receiver, to a transmitter, to an electronic device and to a system enabling a control of jitter management of an audio signal. The invention further relates to a software program product storing a software code for controlling jitter management of an audio signal.

### BACKGROUND OF THE INVENTION

Jitter management is a major issue in Voice over IP (VoIP) design. Network jitter has two components: high frequency component and low frequency component. The conventional jitter buffer holds an initial playback of the incoming voice packet stream to accommodate the high frequency component of jitter. The slowly varying component of the jitter is often resolved by an adaptive jitter buffer, which dynamically changes the target jitter buffer depth according to the network condition. However, both methods introduce initial buffering delay, which may be even several tens of milliseconds in typical wireless network environment.

A traditional VoIP receiver accommodates network jitter by buffering received speech frames and to provide a continuous input to a speech decoder and a subsequent speech playback unit. The jitter buffer stores to this end incoming speech frames for a predetermined amount of time. Such a jitter buffer introduces, however, an additional delay component T_{b}, since the received packets are stored before further processing. The initial playback latency introduced in the buffer adds to the delay of the network leading to a large end-to-end delay of the transmission from a transmitter to a receiver.

A jitter buffer using a fixed delay T_{b} is inevitably a compromise between a low end-to-end delay and a low number of delayed frames.

Typical speech codecs used for VoIP systems are the 3GPP AMR (Adaptive Multirate) codec and the AMR-WB (AMR Wideband) codec. Both codecs are based on a discontinuous transmission (DTX), wherein a Voice Activity Detector (VAD) classifies every frame as active speech frame or non-active speech frame in the transmitter. Non-active frames are passed to a comfort noise parameter computation, that computes parameters of the background noise, and active frames are passed to a speech encoder. A concatenation of active speech frames represents a talk spurt. At the end of the encoded talk spurt the speech encoder of such an DTX system adds several consecutive frames not carrying active speech, wherein said consecutive frames are called DTX hangover. This hangover mechanism enhances voice quality by preventing clipping of perceptually important low energy endings of utterances and supports comfort noise generation at appropriate quality. After this DTX hangover a Silence Descriptor (SID) frame is added subsequently in order to indicate that a comfort noise period starts.

Instead of constant playback buffering, time scaling of speech can be utilised to slow down and speed up the speech playback to accommodate jitter without introducing as large a constant delay. Furthermore, in a DTX system a jitter management with talk spurt time scaling can be used to allow frame playback without long initial buffering delay, while still providing jitter protection for subsequent frames. By starting the playback of the first frame after a silent period, i.e. a first active speech frame of a talk spurt, immediately, the jitter buffer delay T_{b} is omitted and speech signal is available for the user earlier than it would otherwise be played through a traditional jitter buffer. At the same time the first active speech frames are stretched to slow down the playback and hence to accumulate the jitter buffer. In the middle of a talk spurt the jitter buffer delay T_{b} is non-zero in order to provide jitter protection, and near the end of speech, i.e. near the end of a talk spurt, the last speech frames are compressed to speed up the playback and the jitter buffer delay T_{b} is decreased back to zero. This jitter management with talk spurt time scaling enables to reduce end-to-end delay for the transmission of speech frames at the end of a talk spurt leading to decreased perceived delay for a user, wherein a perceived delay is defined by the time duration between the point of time of the end of a talk spurt of a user and the point of time when the same user hears the a response, i.e. a talk spurt, of the other user of the two-way conversation. A perceived delay for a two-way conversation is depicted in FIG. 5.1.

The beginning of a talk spurt is detected when the first active speech frame after disconnected transmission is received in the jitter buffer. Unfortunately, the handling of the end of a talk spurt is challenging for jitter buffer management with talk spurt time scaling for systems applying the AMR or the AMR-WB speech codec, since the usage of the arrival of a SID frame for triggering the end of a talk spurt is far to conservative for talk spurt end detection, because the DTX hangover does not comprise active speech. Hence the jitter buffer management with talk spurt management is in most cases not able to effectively compress the end of a talk spurt in order to decrease jitter buffer delay sufficiently, since the end of received active speech frames is indicated by the next SID frame with a delay introduced by the DTX hangover. Assuming a two-way VoIP conversation from a user A to a user B and back to user A, as depicted in FIG. 5.1, this shows the drawback that due to the insufficient decrease of jitter buffer delay at the end of the talk spurt the end-to-end delay for the transmission of speech frames at the end of the talk spurt increases leading to increased perceived delay for a user.

A straightforward method for talk spurt end detection would be to run the full VAD functionality for the decoded speech to approximate the VAD decision made in the transmitter. However, this would introduce relatively high additional computational complexity, and, furthermore, the VAD decision computed based on decoded speech is not completely reliable, which is likely to reduce the usefulness of this approach.

### SUMMARY OF THE INVENTION

In view of the above-mentioned problem, it is, inter alia, an object of the present invention to improve a jitter buffer management control, which is applied to an audio signal.

A method for controlling jitter management of an audio signal is proposed, said audio signal being distributed to a sequence of frames that are received via a packet switched network, said received frames comprising active audio frames and non-active audio frames, wherein a concatenation of subsequent active audio frames represents an active audio burst, said method comprising receiving discrete information of audio activity of said audio signal via said packet switched network, wherein the end of an active audio burst is determined based on the received discrete information of audio activity, and jitter compensation of said received frames is controlled on the basis of the determined end of the active audio burst.

The transmission of frames via a packet switched network affects delay variation of the received frames, the so called jitter. In order to improve the audio quality at a receiver, a jitter compensation is applied to the received frames. Such a jitter compensation, which may be performed by a jitter buffer, introduces a further delay to the received frames, the so called jitter delay.

The active-audio frames and the non-active audio frames may be generated in a transmitter, wherein a detector detects whether an audio frame, which may be received from an audio source, contains an active audio information or not and then classifies every audio frame as active audio frame or non-active audio frame for transmission. The active audio frames may be encoded by an audio decoder and the non-active audio frames may be passed to a comfort noise generator. This encoding scheme may be represented by a discontinuous transmission (DTX).

E.g., the audio signal may be represented by a VoIP signal, or any other audio signal well-suited for the transmission from a transmitter to a receiver via a packet switched network. Furthermore, the audio signal may be an uncoded signal or a coded signal. In case that the audio signal is represented by a VoIP signal, the audio signal may be encoded by a speech encoder within a transmitter, wherein the speech codec may be the 3GPP AMR or AMR Wideband codec.

According to the present invention, discrete information of audio activity of said audio signal is received via said packet switched network. This discrete information of audio activity may be generated by the detector for classifying the frames as active audio frames or non-active audio frames in a transmitter, and the discrete information of audio activity may indicate whether a frame represents an active audio frame or if it represents a non-active audio frame. Further, the discrete information of audio activity may indicate the end of an active audio burst, and it may indicate the start of an active audio burst. E.g., the discrete information of audio activity may be represented by a signal switched to a high-level for active-audio frames and switched to a low-level for non-active audio frames. This signal may be transmitted in each received frame for indicating the activity status of the corresponding frame.

According to the present invention, the received discrete information of audio activity is used to determine the end of an active audio burst in order to control the jitter management of the audio signal. In the case that the discrete information of audio activity indicates whether a frame represents an active audio frame or if it represents a non-active audio frame, determining the end of a talk spurt may be performed by checking if the preceding received frame is indicated as active audio frame and the subsequent received frame is indicated as non-active audio frame. Furthermore, the discrete information of audio activity may contain information of the number of the last frame of an active audio burst, which may be used to determine the end of an active audio burst.

Based on the determined end of an active audio burst, the jitter compensation performed to the received frames may be controlled in such a way, that the delay introduced by the jitter compensation to the received frames is reduced at the end of an active audio burst in order to decrease end-to-end latency of the transmission at the end of the active audio burst. E.g., the jitter delay may be decreased to zero delay or near to zero delay at the end of an active audio burst. In case that a variable jitter buffer is used for jitter compensation, the buffer delay of the variable jitter buffer may be decreased near the end of the active audio frame and a time-scaling may be applied to the buffered frames in order to compress the active audio frames near the end of the active audio burst.

The presented method for controlling jitter management may be performed for each received active audio burst.

It is an advantage of the present invention that jitter compensation may be controlled efficiently by adjusting jitter delay in order to reduce end-to-end delay for transmission at the end of a period of active audio, since the end of an active audio burst can be determined reliable and immediately on the basis of the received information of audio activity and the jitter buffer delay can be decreased at the end of an active audio burst accordingly. Thus, assuming a two-way conversation, this may decrease the perceived delay.

According to an embodiment of the present invention, the discrete information of speech activity indicates the start and the end of at least one active audio burst of the audio signal.

According to an embodiment of the present invention, the discrete information of audio activity is generated by an audio activity detector, and wherein said audio activity detector is located in a transmitter.

According to an embodiment of the present invention, discrete information of audio activity is transmitted in each frame.

According to an embodiment of the present invention, said received frames are buffered in a variable buffer for compensating for jitter, said variable buffer having a variable buffer delay.

The variable buffer may have a variable buffer size and/or a variable buffer depth.

According to an embodiment of the present invention, the buffer delay is decreased at the end of an active audio burst.

Said decrease of buffer delay may be performed by decreasing the size, i.e. the buffer depth, of the variable jitter buffer. E.g., the buffer delay may be decreased to zero at the end of an active audio burst by emptying out the buffer.

According to an embodiment of the present invention, a time scaling is applied to the buffered frames for compensating for a rate of data transfer during decrease of buffer delay.

This time scaling may be performed by a time scaling unit placed behind the variable jitter buffer. The time scaling may increase the rate of serial data transfer in order to empty the buffer during decreasing the buffer delay. The time scaling may be employed by a windowed time scaling operation having a variable window length.

According to an embodiment of the present invention, the buffer delay is increased at the beginning of an active audio burst.

Said increase of buffer delay may be performed by increasing the size, i.e. the buffer depth, of the variable jitter buffer. E.g., the buffer delay may be increased at the beginning of an active audio burst by accumulating the variable jitter buffer.

The beginning of an active audio burst may be determined by the discrete information of audio activity.

According to an embodiment of the present invention, a time scaling is applied to the buffered frames for compensating for a rate of data transfer during increase of buffer delay.

This time scaling may be performed by the same time scaling unit mentioned above. The time scaling may decrease the rate of serial data transfer in order to accumulate the buffer with received frames during increasing the buffer delay.

According to the present invention, during receiving non-active audio frames the jitter buffer delay may be set to zero. Thus, when the first active audio frame of an active audio burst is received the playback of the audio signal can be started immediately not being delayed by a jitter buffer delay. Correspondingly, the first active audio frames are accumulated in the jitter buffer and the jitter buffer delay is increased in order to compensate for jitters which may be caused by the transmission over the network. Accordingly, time scaling may decrease the rate of serial data transfer of buffered frames during the variable jitter buffer is accumulated with received audio frames while the buffer delay is increased. During this time scaling procedure the playback of the corresponding frames slows down.

During the active audio burst, the jitter buffer may be controlled dependent on network properties in order to achieve a good trade-off between latency and audio quality.

At the end of the active audio burst the buffer delay of the variable buffer is decreased by emptying the variable buffer in order to achieve a reduced end-to-end delay of transmission at the end of the active audio burst. The time scaling increases the rate of serial data transfer of buffered frames in accordance with emptying the variable jitter buffer, wherein the frames near the end of the active audio burst are compressed, so that the playback of the audio signal, e.g. speech, will terminate sooner than it would otherwise be with a fixed jitter buffer delay.

According to an embodiment of the present invention, said received frames after being buffered are fed to a decoder for decoding.

This decoder may comprise a first decoder for decoding the active audio frames and a second decoder for processing the non-active audio frames.

In case that the audio signal represents a coded voice signal, e.g. according to the AMR or the AMR-WB codec, the first decoder may decode active speech frames and the second decoder may generate comfort noise.

The above-mentioned time scaling unit may also be located behind the decoder. Alternatively, the time scaling could be realized for example in combination with another processing function, like a decoding or transcoding function. Combining a pitch-synchronous scaling technique with a speech decoder, for instance, would be a particularly favourable approach to provide a high-quality time scaling capability. For example, with an AMR codec or an AMR-WB codec this provides clear benefits in terms of low processing load.

The output of the decoder may be fed to a playback unit. According to an embodiment of the present invention, said discrete audio activity information is transmitted in a separate signal being different from said audio signal.

According to an embodiment of the present invention, the audio signal is a voice signal, wherein an active audio burst represents a talk spurt, and wherein the discrete information of audio activity represents discrete information of speech activity.

The active audio frames may then represent active speech frames and the non-active audio frames may then represent non-active speech frames.

Thus, the present invention is very suitable for VoIP in order to perform high efficiency jitter management of the received frames with optimised latency of transmission, wherein the above-mentioned objects and features concerning the treatment of active audio bursts also hold for the corresponding treatment of talk spurts.

According to an embodiment of the present invention, the discrete information of speech activity is generated by a voice activity detector located in a transmitter.

Moreover, a chipset with at least one chip is proposed, wherein said at least one chip comprises a jitter management control component for controlling jitter management of an audio signal, said audio signal being distributed to a sequence of frames that are received via a packet switched network, said received frames comprising active audio frames and non-active audio frames, wherein a concatenation of subsequent active audio frames represents an active audio burst, said jitter management control component being adapted to receive discrete information of audio activity of said audio signal via said packet switched network, said jitter management control component being adapted to determine the end of an active audio burst based on the received discrete information of audio activity, and said jitter management control component being adapted to control jitter compensation of said received frames on the basis of the determined end of an active audio burst.

According to an embodiment of the present invention, said jitter management control component is adapted to control a variable buffer for compensating for jitter of received frames, said variable buffer having a variable buffer delay, said jitter management control component is further adapted to increase the buffer delay at the beginning of an active audio burst, and said jitter management control component is further adapted to decrease the buffer delay at the end of an active audio burst.

Moreover, a receiver comprising a jitter management control component for controlling jitter management of an audio signal is proposed, said audio signal being distributed to a sequence of frames that are received via a packet switched network, said received frames comprising active audio frames and non-active audio frames, wherein a concatenation of subsequent active audio frames represents an active audio burst, said jitter management control component being adapted to receive discrete information of audio activity of said audio signal via said packet switched network, said jitter management control component being adapted to determine the end of an active audio burst based on the received discrete information of audio activity, and said jitter management control component being adapted to control jitter compensation of said received frames on the basis of the determined end of an active audio burst.

According to an embodiment of the present invention, said jitter management control component is adapted to control a variable buffer for compensating for jitter of received frames, said variable buffer having a variable buffer delay, said jitter management control component is further adapted to increase the buffer delay at the beginning of an active audio burst, and said jitter management control component is further adapted to decrease the buffer delay at the end of an active audio burst.

It has to be noted, however, that the jitter management control component can be realized by hardware and/or software. The jitter management control component may be implemented for instance in a chipset, or it may be realized by a processor executing corresponding software program code components.

Moreover, an electronic device comprising a jitter management control component for controlling jitter management of an audio signal is proposed, said audio signal being distributed to a sequence of frames that are received via a packet switched network, said received frames comprising active audio frames and non-active audio frames, wherein a concatenation of subsequent active audio frames represents an active audio burst, said jitter management control component being adapted to receive discrete information of audio activity of said audio signal via said packet switched network, said jitter management control component being adapted to determine the end of an active audio burst based on the received discrete information of audio activity, and said jitter management control component being adapted to control jitter compensation of said received frames on the basis of the determined end of an active audio burst.

According to an embodiment of the present invention, said jitter management control component is adapted to control a variable buffer for compensating for jitter of received frames, said variable buffer having a variable buffer delay, wherein said jitter management control component is further adapted to increase the buffer delay at the beginning of an active audio burst, and wherein said jitter management control component is further adapted to decrease the buffer delay at the end of an active audio burst.

The electronic device could be for example a pure audio processing device, or a more comprehensive device, like a mobile terminal or a media gateway, etc.

Moreover, a system is proposed, which comprises a packet switched network adapted to transmit audio signals, a transmitter adapted to provide audio signals for transmission via said packet switched network and a receiver adapted to receive audio signals via said packet switched network. The receiver corresponds to the above proposed audio receiver. Furthermore, the transmitter generates the above-mentioned discrete information of audio activity of said audio signal which is transmitted via said packet switched network to the receiver.

Finally, a software program product is proposed, in which a software code for controlling jitter management of an audio signal is stored, said audio signal being distributed to a sequence of frames that are received via a packet switched network, said received frames comprising active audio frames and non-active audio frames, wherein a concatenation of subsequent active audio frames represents an active audio burst. When being executed by a processor, the software code realizes the proposed method, wherein discrete information of audio activity of said audio signal via said packet switched network is received. The software program product can be for example a separate memory device, a memory that is implemented in an audio receiver, etc.

The invention can be applied to any type of audio codec, in particular, though not exclusively, to any type of speech codec. Further, it can be used for instance for the AMR codec, the AMR-WB codec and any other VoIP codec.

Other objects and features of the present invention will become apparent from the following detailed description considered in conjunction with the accompanying drawings.

It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1: is a schematic block diagram of a transmission system according to an exemplarily embodiment of the invention;

FIG. 2: is a flow chart illustrating an operation in the receiver of FIG. 1;

FIG. 3: is a schematic block diagram of an exemplarily embodiment of a receiver suitable for the transmission system of FIG. 1;

FIG. 4: illustrates frames of a discontinuous transmission operation for the transmission system of FIG. 1;

FIG. 5.1: is a schematic timing diagram for a two-way VoIP conversation with a fixed jitter buffer delay; and

FIG. 5.2: is a schematic timing diagram for a two-way VoIP conversation with controlling jitter management according to the present invention.

### DETAILED DESCRIPTION OF THE INVENTION

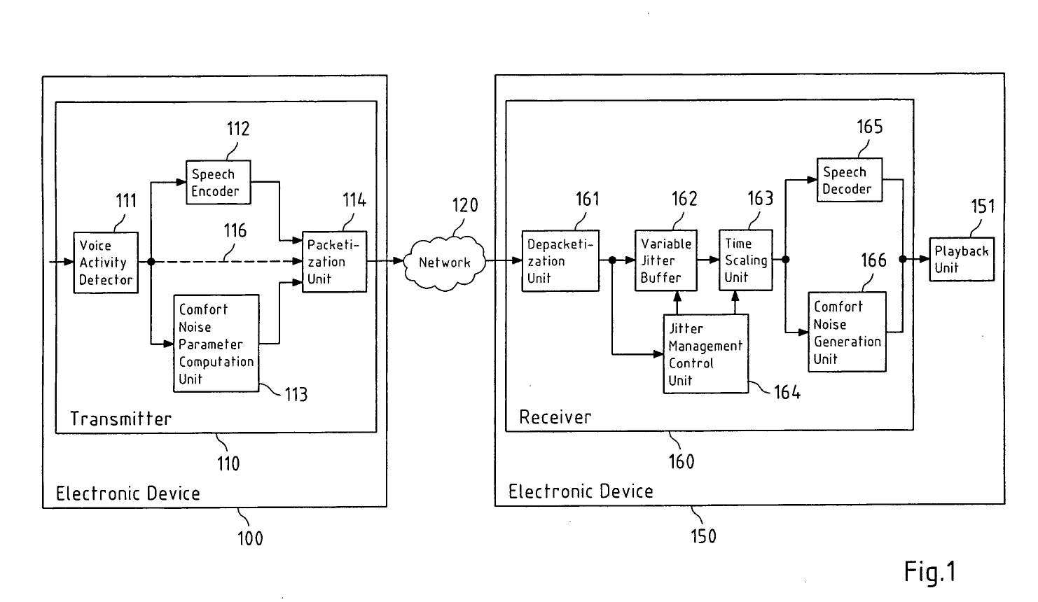

FIG. 1 is a schematic block diagram of an exemplary transmission system, in which enhanced adaptive jitter management control according to an exemplary embodiment of the invention may be implemented.

The system comprises an electronic device 100 with a transmitter 110, a packet switched communication network 120 and an electronic device 150 with a receiver 160. The transmitter 110 may represent a Voice over IP (VoIP) transmitter and the receiver 160 may represent a corresponding VoIP receiver.

The voice activity detector (VAD) 111 receives audio/voice frames from the electronic device 100 and classifies every audio frame as active speech frame or non-active speech frame. Correspondingly the VAD 111 generates discrete information of audio activity, i.e. of speech activity, which indicates whether the actual frame is classified as active speech frame or as non-active speech frame. Thus, the discrete information of audio activity may indicate the start and the end of a talk spurt, wherein a talk spurt represents a concatenation of active speech frames. Such a talk spurt may also be called an active audio burst or an active speech burst.

The active speech frames are fed to the speech encoder 112 for speech encoding and the non-active speech frames are fed to a comfort noise parameter computation unit 113. According to the speech codec applied for transmission, which may be represented by the 3GPP AMR (Adaptive Multi-Rate) codec or by the AMR-WB (AMR Wideband) codec or any other codec suitable for VoIP, the speech encoder generates encoded speech frames and the comfort noise parameter computation unit generates comfort noise frames.

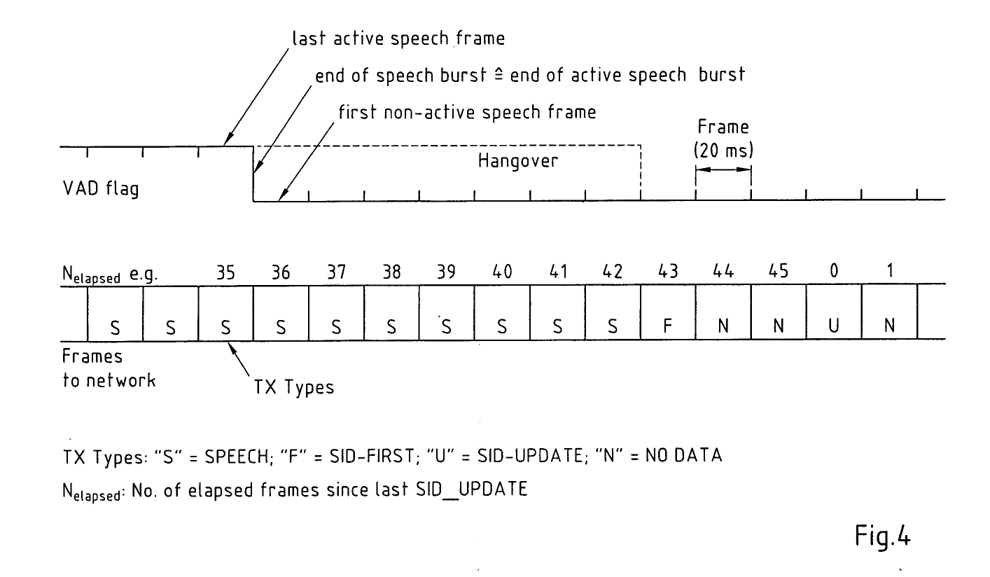

FIG. 4 depicts exemplarily the generation of frames according to the AMR-WB codec using DTX operation with hangover procedure which are transmitted to the network 120 via the packetization unit 114. The frames N_{elapsed}=33, 34, 35 correspond to active speech frames detected by the VAD 111, and thus the corresponding discrete information of audio activity, indicated as VAD flag in FIG. 4, is set to high level for these frames. In case that transmitter 110 represents a VoIP transmitter, the discrete information of audio activity may also be labelled as discrete information of voice activity. After receiving active speech frames and when the first non-active speech frame is received, i.e. at the end of a talk spurt, the AMR-WB encoder generates a DTX hangover comprising several speech frames N_{elapsed}=36 . . . 42 not carrying active speech. Accordingly, the VAD flag is set to low level for the DTX hangover frames. After this DTX hangover a Silence Descriptor (SID) frame, labelled SID_FIRST in FIG. 4, is added subsequently in order to indicate that a comfort noise period starts.

The packetization unit 114 combines the frames generated by the speech encoder 112 and generated by the comfort noise parameter computation unit 113 and transmits these frames in form of packets via the packet network 120 to the receiver 160 within the electronic device 150.

According to the present invention, the discrete information of speech activity generated by the VAD 111 is also transmitted via the packet network 120 to the receiver 160 within the electronic device 150. In case of AMR-WB transmission, the AMR-WB bitstream already contains discrete information of speech activity generated from the VAD 111 in each frame, i.e. the VAD flag depicted in FIG. 4 is inserted in each frame.

For other audio/voice codecs, the discrete information of audio/speech activity generated may be inserted into the frames for transmission in the packetization unit 114, e.g. by use of the optional dashed signal path 116 shown in FIG. 1, or the discrete information of speech activity may be inserted by the speech encoder 112 and the comfort noise parameter computation unit 113 into the frames for transmission, or the discrete information of speech activity may be transmitted in a signal being separate from the frames generated by the speech encoder 112 and the comfort noise parameter computation unit 113 to the receiver 160 within the electronic device 150. E.g., for AMR codec the transmission of the discrete information of speech activity could be implemented for example by transmitting it using the unused bits of the AMR/AMR-WB RTP payload format or by exploiting the RTP header extension mechanism.

As depicted in the exemplary embodiment of a transmission system in FIG. 1, the frames transmitted from the transmitter 110 within the electronic device 100 are received by the receiver 160 within electronic device 150 by the depacketizing unit 161. This depacketizing unit 161 may comprise a separate buffer for storing these received frames.

The depacketizing unit 161 passes the received frames to the variable jitter buffer 162. The variable jitter buffer 162 may have the capability to arrange received frames into the correct decoding order and to provide the arranged frames—or information about missing frames—in sequence to the speech decoder 165 and/or the comfort noise generation unit 166 upon request.

Furthermore, the variable jitter buffer 162 has the capability of a variable jitter buffer delay. This variable jitter buffer delay is controlled by the jitter management control unit 164, wherein the jitter management control unit 164 controls the variable jitter buffer 162 on the basis of the received discrete information of audio activity. The variable jitter buffer delay may be achieved by a variable buffer size of the variable jitter buffer 162.

The variable jitter buffer 162 is connected via a time scaling unit 163, a speech decoder 165 and a comfort noise generation unit 166 to the output of the receiver 160. A first control signal output of the jitter management control unit 164 is connected to the variable jitter buffer 162, while a second control signal output of the jitter management control unit 164 is connected to the time scaling unit. Furthermore, the jitter management control unit 164 is connected to the output of the depacketization unit 161.

The time scaling unit 163 may be used to increase the rate of serial data transfer of frames in order to empty the variable jitter buffer 162 when the buffer delay is decreased. Furthermore, the time scaling unit 163 may be used to decrease the rate of serial data transfer of frames when the variable jitter buffer 162 is filled up with received frames during increasing buffer delay. The time scaling may be employed by a windowed time scaling operation having a variable window length.

After passing the variable jitter buffer 162 and the time scaling unit 163 the active speech frames are decoded by the speech decoder 165 in accordance with the applied speech codec, and the comfort noise generation unit 166 generates comfort noise based on the non-active speech frames in accordance with the applied speech codec. The output of the speech decoder 165 and of the comfort noise generation unit form the decoded audio signal which represents the output of the receiver 160.

The output of the receiver 160 may be connected to a playback component 151 of the electronic device 150, for example to loudspeakers.

The jitter management control unit 164 is used to control the variable jitter buffer 162 and to control the time scaling unit 163, respectively. In particular, the jitter management control unit 164 receives the discrete information on audio/voice activity, and the jitter management control unit 164 may receiver further information on the received frames from the depacketization unit 161. Furthermore, the jitter management control unit 164 may receive further information on the network status of network 120 from a network analyser (not shown).

The jitter management control unit 164 controls the variable jitter buffer 162 and the time scaling unit 163 on the basis of the received discrete audio/voice activity information. Furthermore, the jitter management control unit 164 may use further information on the received frames and/or further information on the network status for controlling the variable jitter buffer 162 and the time scaling unit 163.

The jitter management control unit 164 may be implemented by a software code that can be executed by a processor of the receiver 160. It is to be understood that the same processor could execute in addition software codes realizing other functions of the receiver 160 or, in general, of the electronic device 150. It has to be noted that, alternatively, the functions of the jitter management control unit 164 could be realized by hardware, for instance by a circuit integrated in a chip or a chipset.

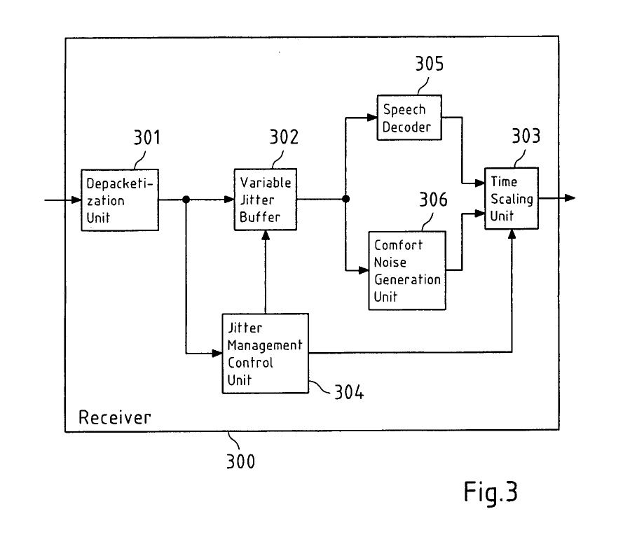

An alternative exemplary embodiment of the receiver according to the present invention is depicted in FIG. 3, wherein the time scaling unit 303 is placed at the output of the speech decoder 305 and the output of the comfort noise generation unit 306. The components depacketization unit 301, variable jitter buffer 302, jitter management control unit 304, speech decoder 305, comfort noise generation unit 306 and the time scaling unit 303 have the same functions as the corresponding components depicted in exemplarily receiver 160.

A third alternative exemplary embodiment of the receiver according to the present invention is similar to the receiver 300 as depicted in FIG. 3, wherein the time scaling unit 303 is placed within the speech decoder 305 and the comfort noise generation unit 306, and wherein the jitter management control unit 304 is connected to the speech decoder 305 and the comfort noise generation unit 306, respectively, in order to control the time scaling unit placed therein. The components depacketization unit 301, variable jitter buffer 302, jitter management control unit 304, speech decoder 305, comfort noise generation unit 306 and the time scaling unit 303 have the same functions as the corresponding components depicted in exemplarily receiver 160.

It is to be understood that the exemplarily presented architecture of the receiver 160 of FIG. 1 is only intended to illustrate the basic logical functionality of an exemplary receiver according to the invention. In a practical implementation, the represented function can be allocated differently to processing blocks. Some processing blocks of an alternative architecture may combine several ones of functions described above. Furthermore, there may be additional processing blocks, and some components, like the jitter management control 164 and/or the variable jitter buffer 162 may be arranged outside of the receiver 160. The same holds for the alternative exemplary embodiment of the receiver according to the present invention shown in FIG. 3.

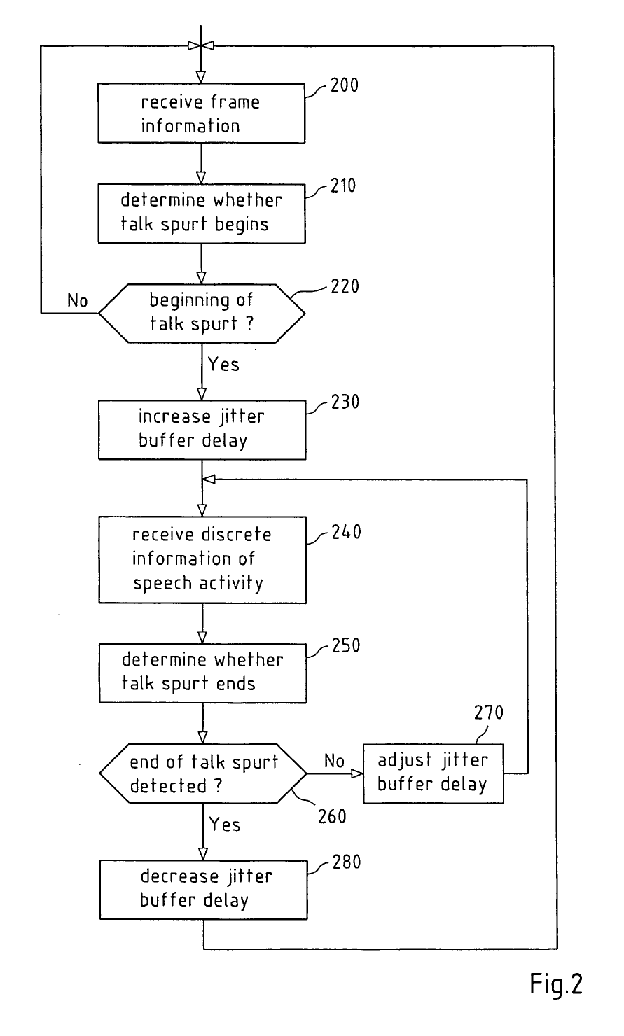

A jitter management control according to an exemplary embodiment of the invention will now be described with reference to the flow chart of FIG. 2 and assuming that the transmission system depicted in FIG. 1 is applied, wherein the AMR-WB speech codec for VoIP is used exemplarily for transmission of a voice signal.

It is now assumed without any restriction that a talk spurt has not been started and that the depacketizing 161, 301 unit receives non-active speech frames, i.e. a silent period is transmitted actually, so that the jitter management control unit 164, 304 may start with step 200 accordingly. During this silent period the variable jitter buffer 162, 302 is fed with non-active speech frames which are passed to the comfort noise generation unit 166, 306 in order to generate comfort noise. During this silent period it is assumed that the jitter management control unit 164, 304 sets the buffer delay of the variable jitter buffer 162, 302 to zero. Instead of this assumed zero jitter buffer delay, a jitter buffer delay being different from zero may also be applied.

Thus, the jitter management control receives information on the received frames from the depacketization unit 161, 301 (step 200). Assuming that the AMR-WB codec is applied, this information may be the DTX information of the frames, which may indicate whether a frame represents a speech frame, a SID frame, or a no data frame, wherein the SID frame or no data frame may correspond to a non-active voice frame. Please note, that a speech frame does not necessarily represent an active speech frame since also the DTX hangover frames are indicated as speech frames, as depicted in FIG. 4. Furthermore, also the received discrete information of audio/speech activity may be used as frame information in step 200.

Based on this received frame information, it is determined by the jitter management control unit 164, 304 in step 210 whether a talk spurt begins.

If the jitter management control unit 164, 304 detects that the received frame is a non-active speech frame, and thus it is determined in step 210 that no talk spurt begins, in step 220 the jitter management control will go back to step 200 in order to receive information of the next received frame (step 200).

If it is determined in step 210 that the received frame is an active speech frame and thus a talk spurt begins, the jitter management control unit 164, 304 decides at step 200 to proceed further with step 230.

Since the buffer delay is assumed to be zero at this time the first received active speech frame is passed immediately to the speech decoder 165, 305 and the encoded speech signal at the beginning of the talk spurt is available to the speech decoder 165, 305 without any jitter delay.

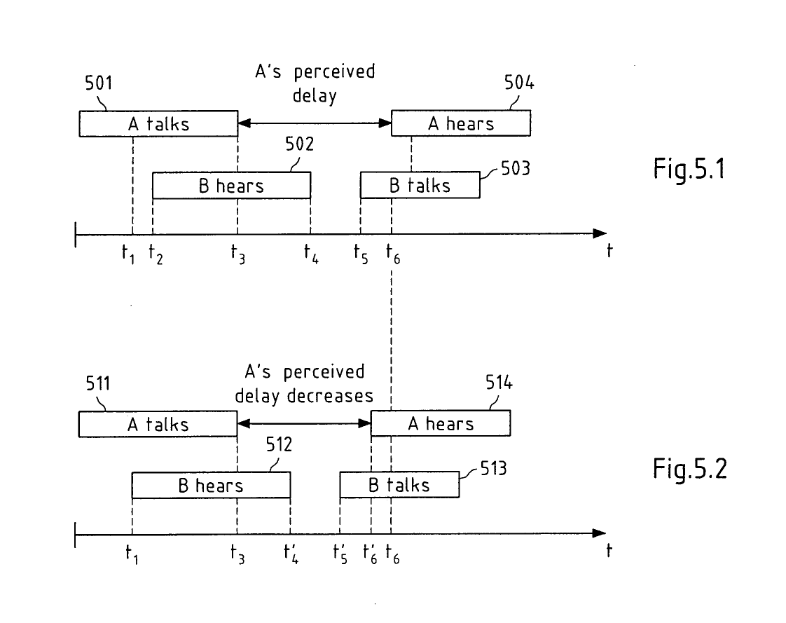

FIGS. 5.1 and 5.2 show exemplarily timing diagrams for a two-way conversation from a user A to a user B and back from user B to user A applying a VoIP transmission, wherein FIG. 5.1 depicts the timing diagram for a fixed jitter buffer delay T_{b}=t₂−t₁ and FIG. 5.2 depicts the timing diagram for a variable jitter buffer delay according to the present invention. t₁ indicates the point in time when talk spurt 501 from user A receives at the receiver of user B, but a further delay of T_{b}=t₂−t₁ is introduced by the fixed jitter buffer delay caused by the jitter buffer in user B's receiver. Thus, the received talk spurt starts at t₂. Contrary to this, according to the present invention, the received talk spurt 512 starts immediately at t₁, leading to a decreased perceived delay for user A.

According to step 230, the jitter buffer delay of the variable jitter buffer 162, 302 is now increased. This may be achieved by filling up the jitter buffer with the received active speech frames. Accordingly, the jitter management control unit 164, 304 stretches the received active speech frame by decreasing the rate of serial data transfer of frames during the variable jitter buffer 162, 302 is filled up with received speech frames while the buffer delay is increased according to step 230. During this time scaling procedure the playback of the corresponding frames slows down.

In the next step 240 the jitter management control unit 164, 304 receives the discrete information of speech activity which indicate whether the talk spurt ends or not. Based on this discrete information of speech activity the jitter management control unit 164, 304 determines whether the received talk spurt ends in step 250. For example, assuming the AMR-WB codec and as depicted in FIG. 4, the VAD flag (see FIG. 4) may represent the discrete information of speech activity, wherein a high level of said VAD flag indicates that the corresponding frame is an active speech frame and thus corresponds to a talk spurt, whereas a low level of said VAD flag indicates a non-active speech frame. If the last received frame has been indicated as active speech frame, and the subsequent received frame is indicated as non-active speech frame, the jitter management control unit 164, 304 determines in step 240 that the talk spurt ends.

If the actual received frame is an active speech frame, and thus the talk spurt does not end, it is decided in step 260 to proceed further with step 270 in order to adjust the jitter buffer delay.

In step 270 the jitter management control unit may determine an optimum jitter buffer delay based on the received information from the network analyser mentioned above and/or based on other information. This optimum jitter buffer delay may depend on a maximum tolerable delay time for the transmission from the transmitter to the output of the receiver and may also depend on the required jitter buffer size, and thus the required jitter buffer delay time in order to achieve a sufficient jitter compensation to received frames. When the optimum jitter buffer delay is reached, it may be advantageous to fix this optimum jitter buffer delay in order to avoid decrease of audio quality.

For example, at the beginning of a talk spurt the jitter management control unit may increase the jitter buffer delay as described in step 230, wherein in parallel the time scaling to the buffered frames may be applied as explained above in order to stretch the buffered frames.

Furthermore, if it is detected in step 270 that the transmission over the packet switched network 120 introduces less jitter to the frames than before or that the actual value of jitter buffer delay is too high, the jitter buffer delay may be decreased and in parallel the time scaling to the buffered frames may be compressed.

After adjusting the jitter buffer delay at step 270 the jitter management control unit goes back to step 240 for receiving discrete information of speech activity.

If it is determined in step 250 that the talk spurt ends based on the received discrete information of speech activity, which may be indicated in case of the AMR-WB codec by a low-level VAD flag, the jitter management control unit 164, 304 decides in step 260 to proceed with step 280 in order to decrease the jitter buffer delay.

Before decreasing the jitter buffer delay (step 280) the variable jitter buffer 162, 302 may contain a plurality of active-speech frames. In order to decrease the jitter buffer delay the variable jitter buffer may be emptied and the jitter management control unit 164, 304 may control the time scaling unit to this active-speech frames buffered to increase the rate of serial data transfer of frames in accordance with emptying the variable jitter buffer, wherein the frames near the end of the talk spurt are compressed, so that the playback of speech will terminate sooner than it would otherwise be with a fixed jitter buffer delay.

Due to this decrease of jitter buffer delay and the correspondingly time-scaling the playback of the speech at the end of the talk spurt is accelerated in the time length of the playbacked talk spurt, e.g. represented as talk spurt 512 in FIG. 5.2, is reduced. Assuming a two-way conversation as depicted in FIGS. 5.1 and 5.2, a user B hearing this talk spurt 512 may react faster with a response 513 to the other user A leading to a decreased perceived delay for user A.

Thus, according to the present invention the conversational delay perceived by a user is decreased.

Assuming that the AMR-WB codec is applied, the present invention enables a reliable and immediate detection of the end of a talk spurt, which would not be achieved when the DTX information would be used for the detection of the end of a talk spurt, because the first SID identifier appears eight frames too late with respect to the end of the preceding talk spurt since the non-active speech frames are transmitted during the DTX hangover period before the first SID identifier indicates a non-speech signal or a silence period, as depicted on FIG. 4. Thus, according to the present invention, a faster talk spurt end detection is achieved.

After decreasing the jitter buffer delay (step 280) the jitter management control unit goes back to step 200 in order to detect the next talk spurt and to proceed on as explained above.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling jitter management of an audio signal, said audio signal being distributed to a sequence of frames that are received via a packet switched network, said received frames comprising active audio frames and non-active audio frames, wherein a concatenation of subsequent active audio frames represents an active audio burst, said method comprising:
receiving discrete information of audio activity of said audio signal via said packet switched network;
determining the end of an active audio burst based on the received discrete information of audio activity; and
controlling jitter compensation of said received frames on the basis of the determined end of an active audio burst.

2. The method according to claim 1, wherein the discrete information of speech activity indicates the start and the end of at least one active audio burst of the audio signal.

3. The method according to claim 1, wherein the discrete information of audio activity is generated by an audio activity detector, and wherein said audio activity detector is located in a transmitter.

4. The method according to claim 1, wherein the discrete information of audio activity is transmitted in each frame.

5. The method according to claim 1, wherein said received frames are buffered in a variable buffer for compensating for jitter, said variable buffer having a variable buffer delay.

6. The method according to claim 5, wherein the buffer delay is decreased at the end of an active audio burst.

7. The method according to claim 6, wherein a time scaling is applied to the buffered frames for compensating for a rate of data transfer during decrease of buffer delay.

8. The method according to claim 1, wherein the buffer delay is increased at the beginning of an active audio burst.

9. The method according to claim 8, wherein a time scaling is applied to the buffered frames for compensating for a rate of data transfer during increase of buffer delay.

10. The method according to claim 5, wherein said received frames after being buffered are fed to a decoder for decoding.

11. The method according to claim 1, wherein said discrete audio activity information is transmitted in a separate signal being different from said audio signal.

12. The method according to claim 1, wherein the audio signal is a voice signal, wherein an active audio burst represents a talk spurt, and wherein the discrete information of audio activity represents discrete information of speech activity.

13. The method according to claim 12, wherein the discrete information of speech activity is generated by a voice activity detector located in a transmitter.

14. A chipset with at least one chip, said at least one chip comprising a jitter management control component for controlling jitter management of an audio signal, said audio signal being distributed to a sequence of frames that are received via a packet switched network, said received frames comprising active audio frames and non-active audio frames, wherein a concatenation of subsequent active audio frames represents an active audio burst,
said jitter management control component being adapted to receive discrete information of audio activity of said audio signal via said packet switched network;
said jitter management control component being adapted to determine the end of an active audio burst based on the received discrete information of audio activity; and
said jitter management control component being adapted to control jitter compensation of said received frames on the basis of the determined end of an active audio burst.

15. The chipset according to claim 14, wherein
said jitter management control component being adapted to control a variable buffer for compensating for jitter of received frames, said variable buffer having a variable buffer delay,
said jitter management control component being adapted to increase the buffer delay at the beginning of an active audio burst, and
said jitter management control component being adapted to decrease the buffer delay at the end of an active audio burst.

16. A receiver comprising a jitter management control component for controlling jitter management of an audio signal, said audio signal being distributed to a sequence of frames that are received via a packet switched network, said received frames comprising active audio frames and non-active audio frames, wherein a concatenation of subsequent active audio frames represents an active audio burst,
said jitter management control component being adapted to receive discrete information of audio activity of said audio signal via said packet switched network;
said jitter management control component being adapted to determine the end of an active audio burst based on the received discrete information of audio activity; and
said jitter management control component being adapted to control jitter compensation of said received frames on the basis of the determined end of an active audio burst.

17. The receiver according to claim 16, wherein
said jitter management control component being adapted for controlling a variable buffer for compensating for jitter of received frames, said variable buffer having a variable buffer delay,
said jitter management control component being adapted to increase the buffer delay at the beginning of an active audio burst, and
said jitter management control component being adapted to decrease the buffer delay at the end of an active audio burst.

18. An electronic device comprising a jitter management control component for controlling jitter management of an audio signal, said audio signal being distributed to a sequence of frames that are received via a packet switched network, said received frames comprising active audio frames and non-active audio frames, wherein a concatenation of subsequent active audio frames represents an active audio burst,
said jitter management control component being adapted to receive discrete information of audio activity of said audio signal via said packet switched network;
said jitter management control component being adapted to determine the end of an active audio burst based on the received discrete information of audio activity; and
said jitter management control component being adapted to control jitter compensation of said received frames on the basis of the determined end of an active audio burst.

19. The electronic device according to claim 18, wherein
said jitter management control component being adapted to control a variable buffer for compensating for jitter of received frames, said variable buffer having a variable buffer delay,
said jitter management control component being adapted to increase the buffer delay at the beginning of an active audio burst, and
said jitter management control component being adapted to decrease the buffer delay at the end of an active audio burst.

20. A system comprising a packet switched network adapted to transmit audio signals, a transmitter adapted to provide audio signals for transmission via said packet switched network and a receiver adapted to receive audio signals via said packet switched network, said receiver including a jitter management control component for controlling jitter management of an audio signal, which audio signal is distributed to a sequence of frames that are received via said packet switched network, said received frames comprising active audio frames and non-active audio frames, wherein a concatenation of subsequent active audio frames represents an active audio burst,
said jitter management control component being adapted to receive discrete information of audio activity of said audio signal via said packet switched network from said transmitter;
said jitter management control component being adapted to determine the end of an active audio burst based on the received discrete information of audio activity; and
said jitter management control component being adapted to control jitter compensation of said received frames on the basis of the determined end of an active audio burst.

21. The system according to claim 20, wherein
said jitter management control component being adapted to control a variable buffer for compensating for jitter of received frames, said variable buffer having a variable buffer delay,
said jitter management control component being adapted to increase the buffer delay at the beginning of an active audio burst, and
said jitter management control component being adapted to decrease the buffer delay at the end of an active audio burst.

22. A software program product in which a software code for controlling jitter management of an audio signal is stored, said audio signal being distributed to a sequence of frames that are received via a packet switched network, said received frames comprising active audio frames and non-active audio frames, wherein a concatenation of subsequent active audio frames represents an active audio burst, wherein said software code realizes the following steps when being executed by a processor:
receiving discrete information of audio activity of said audio signal via said packet switched network;
determining the end of an active audio burst based on the received discrete information of audio activity; and
controlling jitter compensation of said received frames on the basis of the determined end of an active audio burst.

23. The software program product according to claim 22, wherein said software code when being executed by a processor realizes the further steps of:
controlling a variable buffer for compensating for jitter of received frames, said variable buffer having a variable buffer delay,
increasing the buffer delay at the beginning of an active audio burst, and
decreasing the buffer delay at the end of an active audio burst.
